(19) United States
(12) Patent Application Publication
(10) Pub. No.: US 2006/0130304 A1
(43) Pub. Date: Jun. 22, 2006

(54) Extraction tool

(76) Inventor: Gilles Roy, Laval (CA)

Correspondence Address: Louis Tessier, P.O. Box 54029, Town of Mount-Royal, QC, H3P 3H4, CA

(21) Appl. No.: 11/016,775

(22) Filed: Dec. 21, 2004

(51) Int. Cl. B23P 19/04

(52) U.S. Cl. 29/254

(57) ABSTRACT

An extraction tool for extracting an object. The extraction tool includes a gripping portion for gripping the object and an impact generating portion connected to the gripping portion. The impact generating portion includes the guiding section, a mobile section connected to the guiding section and mobile with respect thereto, and a stopper connected to the guiding section for stopping a motion of the mobile section. Upon the mobile section being accelerated towards the stopper and thereafter stopped thereby, the mobile section exerts an impact force onto the stopper. The impact force is transmitted to the object through the gripping portion. The impact force is directed substantially away from the gripping portion.

### FIELD OF THE INVENTION

The present invention relates to tools. More specifically, the present invention is concerned with an extraction tool.

### BACKGROUND OF THE INVENTION

In the construction industry, there are many methods and devices for assembling structures that involve connectors that frictionally engage one, two, or more than two objects in order to keep them interconnected. For example, some ventilation ducts include a substantially L-shaped flange at each extremity, which therefore form with the duct U-shaped extremities. Then, two ducts that are to be connected together are aligned such that their U-shaped extremities face each other and a connector is used that frictionally engages the U-shaped extremities of each of the ducts.

More specifically, it is known to interconnect two ducts having substantially square or substantially rectangular cross sections using four connectors, each connecting a side of each duct to a corresponding side of the other duct. Assembly of such structures is relatively straightforward as the connectors are simply pushed either by hand or using a tool, such as a hammer, to push the connector onto the U-shaped extremities.

While assembly of such duct structures is relatively straightforward, when time comes to disassemble the structure, there are currently no efficient ways to perform the disassembly. Therefore, construction workers typically use screwdrivers, or other tools, to try to disconnect the connectors from the flanges. Also, workers may use pliers or grips and pull on the connectors.

Since the worker uses tools that are not specifically built for such disassembly, there is a risk that the tool may slip and harm the worker. Also, since ventilation ducts are typically installed at a relatively high height above ground, there is also a risk that the construction worker trying to extract a connector exerts too much force and that the connector suddenly separates from the ducts. In this case, if the force exerted by the worker is strong enough, there is a risk that the worker will fall off the structure used to attain the height of the connectors, which could cause grave injuries and eventually death to the worker.

In addition, in the above-described task and in many other tasks, the frictional engagement of the connector with the objects to connect is relatively strong. Accordingly, there is a need to exert considerable force onto the connector to overcome the friction between the connector and the objects to be connected. It is relatively hard to exert such force as typically connectors are configured such that they arrive flush with the objects to connect so as to improve the aesthetic aspect of the completed assembly.

Furthermore, the absence of specialized tools to perform such disassembly renders these tasks relatively expensive to perform as they are relatively time consuming.

Against this background, there exists a need in the industry to provide a novel extraction tool.

### OBJECTS OF THE INVENTION

An object of the present invention is therefore to provide an improved extraction tool.

### SUMMARY OF THE INVENTION

In a first broad aspect, the invention provides an extraction tool for extracting an object. The extraction tool includes a gripping portion for gripping the object and an impact generating portion connected to the gripping portion. The impact generating portion includes a guiding section, a mobile section connected to the guiding section and mobile with respect thereto, and a stopper connected to the guiding section for stopping a motion of the mobile section. Upon the mobile section being accelerated towards the stopper and thereafter stopped thereby, the mobile section exerts an impact force onto the stopper. The impact force is transmitted to the object through the gripping portion. The impact force is directed substantially away from the gripping portion.

Advantageously, the generation of an impact by the mobile section allows overcoming a friction between the object, which in some embodiments of the invention, but non-limitatively, is a connector for connecting ducts, and other objects that are connected by the connector. In addition, since the mobile section is mobile with respect to the tool, but the tool is substantially fixed before the mobile section generates the impact, risk of the worker losing equilibrium when using the tool are substantially reduced.

In addition, the tool helps in performing a relatively fast extraction of the object, which reduces the cost of disassembling the structure substantially. Also, the extraction tool is relatively simple to manufacture and therefore sellable at a relatively small cost.

In a second broad aspect, the invention provides an extraction tool for extracting an object, the extraction tool being usable by a user. The extraction tool includes a gripping portion for gripping the object. The gripping portion including a body, a first mobile jaw, the first mobile jaw being connected to the body and mobile with respect thereto, the first mobile jaw including at least one first jaw tooth for engaging the object, and a second jaw connected to the body. The extraction tool further includes a handle connected to the body. The body and the first and second jaws are configured and sized for gripping the object with a gripping force, the gripping force increasing with an extraction force exerted onto the handle by the user. The extraction force is exerted by the user substantially away from the object.

In a third broad aspect, the invention provides an extraction tool for extracting an object, the extraction tool being usable by a user. The extraction tool includes a first jaw including a first gripping surface for gripping the object, the first jaw further including an external surface substantially opposed to the first gripping surface. The extraction tool also includes a second jaw including a second gripping surface for gripping the object and an actuator contacting the first jaw through the external surface. The first and second jaws are coupled together for movement between an open and a closed configuration. In the open configuration, the object is mobile between the first and second gripping surfaces, and in the closed configuration, the object is gripped by the first and second gripping surfaces. The actuator is configured and sized so that upon the user exerting a force on the tool directed substantially away from the object, the actuator exerts a force on the external surface directed so that the first and second gripping surfaces are pressed substantially towards each other to adopt the closed configuration.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a perspective view of an extraction tool;

FIG. 2 is a side elevation view of a gripping portion of the extraction tool of FIG. 1;

FIG. 3 is a partially exploded side cross-section view of the gripping portion illustrated in FIG. 2;

FIG. 4 illustrates a specific application of the gripping tool of FIG. 1;

FIG. 5 is a top elevation view of the gripping portion of FIG. 2; and

FIG. 6 illustrates a mobile section of the extraction tool of FIG. 1 in a side elevation view.

### DETAILED DESCRIPTION

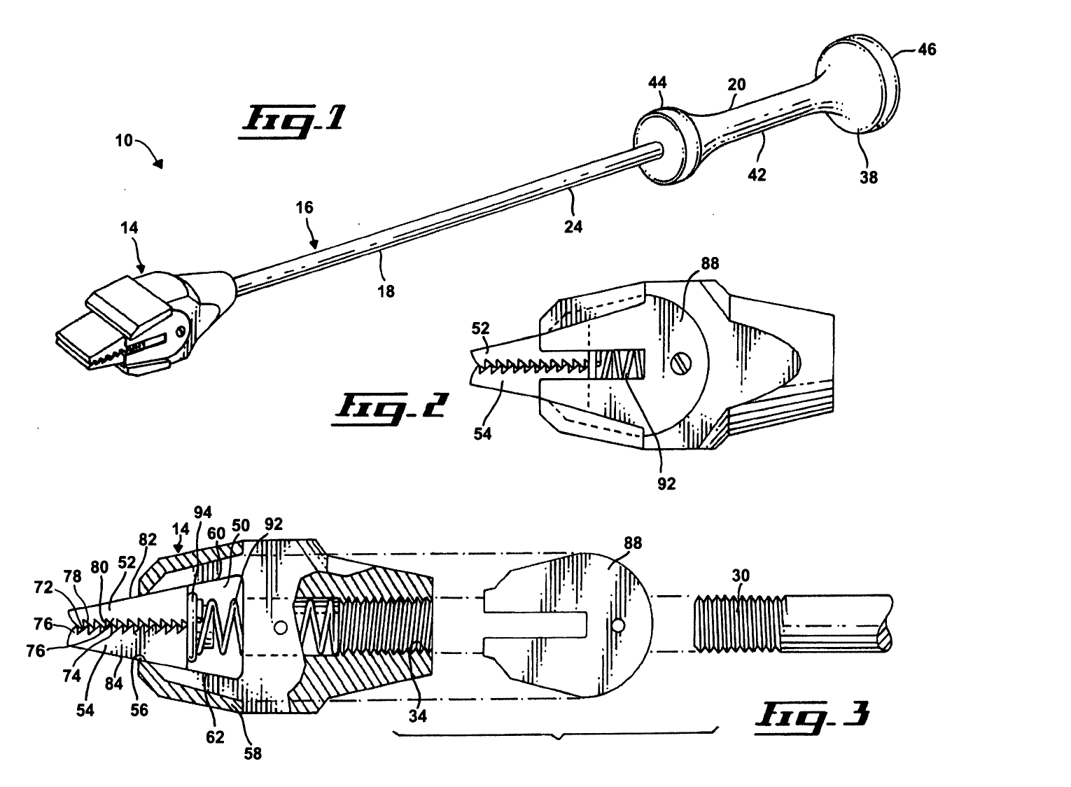

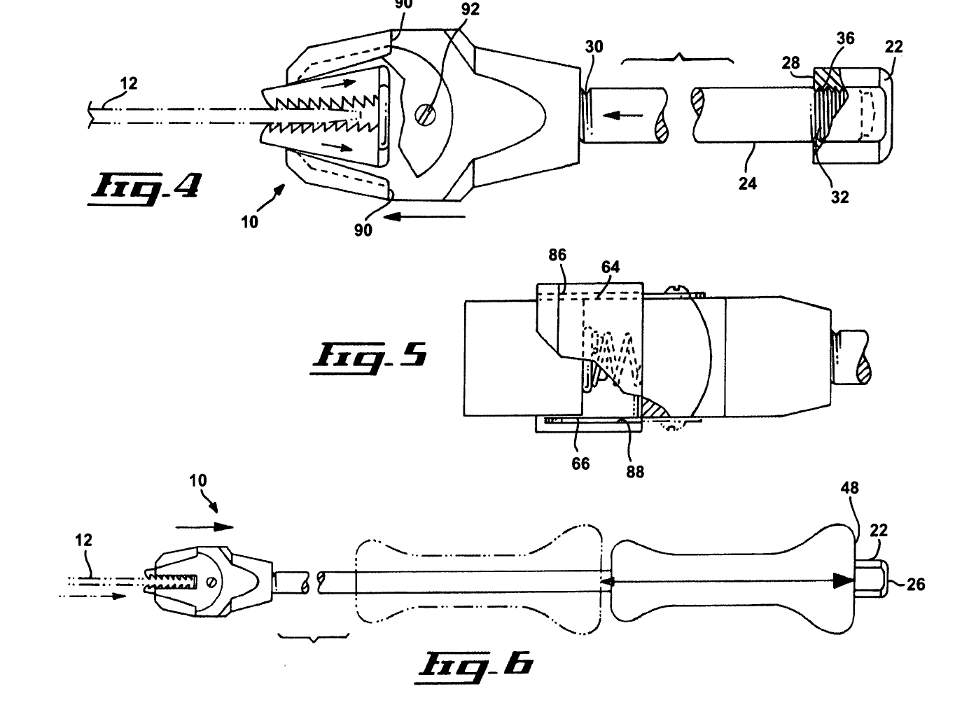

FIG. 1 illustrates an extraction tool for extracting an object 12 (shown in FIGS. 4 and 6). The extraction tool includes a gripping portion 14 for gripping the object 12, and an impact generating portion 16 connected to the gripping portion 14.

The impact generating portion includes a guiding section 18, a mobile section 20 connected to the guiding section 18 and mobile with respect thereto, and a stopper 22 (shown in FIGS. 4 and 6) connected to the guiding section 18 for stopping the motion of the mobile section 20.

Upon the mobile section 20 being accelerated towards the stopper 22, and thereafter stopped thereby, the mobile section 20 exerts an impact force onto the stopper 22. The impact force is transmitted to the object 12 through the gripping portion 14. The impact force is directed substantially away from the gripping portion 14.

In other words, the extraction tool 10 is a manually operated impact tool for exerting an impact force onto the object 12. The impact tool includes an impact force transmitting portion for transmitting the impact force to the object. In some embodiments of the invention, the impact force transmitting portion includes a gripping portion, such as the gripping portion 14. However, in alternative embodiments of the invention, the impact force transmitting portion is any other suitable impact force transmitting portion.

The impact tool further includes an impact force generating portion connected to the impact force transmitting portion. The impact force generating portion includes, for example, the guiding section 18, the mobile section 20 connected to the guiding section 18 and mobile with respect thereto, and the stopper 22 connected to the guiding section 18 for stopping the motion of the mobile section 20.

Accordingly, upon the mobile section 20 being accelerated towards the stopper 22 and thereafter stopped thereby, the mobile section 20 exerts an impact force onto the stopper 22. The impact force is transmitted to the impact force transmitting portion.

In some embodiments of the invention, a stopper for the impact tool is not the stopper 22 and instead is a stopper provided in proximity to the impact force transmitting portion. Accordingly, in these embodiments of the invention, the mobile section is accelerated towards the impact force transmitting force and therefore the impact force is directed substantially towards the object.

In specific embodiments of the invention, sliding the mobile section 20 with respect to the guiding section 18 allows for the impact to be generated onto the impact force transmitting portion without requiring that the impact tool is moved with respect to the object 12.

Accordingly, an intended user relatively easily stabilizes the impact tool and thereafter exerts the impact to overcome, for example, a frictional force between the object 12 and an item (not shown in the drawings). In some cases, the impact force is exerted so that the object 12 is inserted to connect two items. In other embodiments of the invention, the impact force is exerted so that the object is pulled such as to detach the object from the two items.

In other words, an impact tool, such as impact tool 10, includes a gripping portion 14 for gripping the object 12, an energy accumulator for receiving and storing energy and an impact generator connected to the gripping portion 12 and to the energy accumulator, the impact generator being for producing an impact force from the stored energy. The impact force is directed substantially away from the gripping portion 14.

An example of an energy accumulator is the mobile section 20 which, upon being accelerated by an intended user, acquires kinetic energy. This kinetic energy is transferred to the rest of the tool upon the mobile section 20 contacting the stopper 22.

However, in alternative embodiments of the invention, the energy accumulator is any suitable energy accumulator including, for example and non-limitatively, a pneumatic energy accumulator, an elastic energy accumulator that accumulates energy within a biasing element, or any other suitable energy accumulator.

In some embodiments of the invention, the energy is accumulated over a length of time that is substantially smaller than a length of time through which the energy is provided to generate the impact force. Accordingly, a relatively small amount of power exerted over a relatively long duration generates at the time of the impact force a relatively large power exerted over a relatively short duration. This relatively large power helps in overcoming relatively easily frictional resistance or any other resistance exerted onto the object.

In some embodiments of the invention, the gripping portion 14 is configured and sized for using, at least in part, the stored energy to grip the object 12 tighter upon the production of the impact force.

A specific example of an extraction tool, extraction tool 10, is further described hereinbelow. As shown in the drawings, the guiding section 18 includes a shaft 24. The shaft 24 is substantially rectilinear, substantially elongated and substantially uniform in cross section, the cross section being substantially circular. However, in alternative embodiments of the invention, the shaft 24 takes any suitable form.

For example, in other embodiments of the invention, a shaft is of substantially square, rectangular or any other polygonal cross section. In other embodiments of the invention, the cross section of a shaft is not substantially uniform along its length.

The stopper 22 includes a stopping member 26 connected to the shaft 24 and extending at least in part substantially outwardly and substantially radially therefrom. Accordingly, in some embodiments of the invention, the stopper 26 defines a flange substantially perpendicular to the shaft 24, as shown in FIG. 4.

The shaft 24 is removably attached to the stopper 22 and to the gripping portion 14. To that effect, the shaft 24 includes first and second threaded ends 30 and 32. Also, the gripping portion 14 defines a gripping portion threaded bore 34, shown in FIG. 3. In addition, the stopper 22 also defines a threaded bore, namely a stopper threaded bore 36. The gripping portion threaded bore 32 is for receiving the first threaded end 30; while the second threaded end 32 is received by the stopper threaded bore 36.

The mobile portion 20 includes a mobile member 38 defining an insertion bore extending therethrough (not shown in the drawings). The insertion bore is for receiving, at least in part, the shaft 24. In some embodiments of the invention, the mobile member is slidably mounted onto the shaft 24. Furthermore, the mobile member 38 defines a handle for receiving the hand of an intended user.

Since the mobile portion 20 generates the impact force, the mobile member 38 needs to be of a suitable mass to generate a suitable impact force. In a specific example of implementation, the mobile member 38 has a mass of between about 550 and about 650 grams. In other specific example of implementations, the mobile member 38 has a mass of between about 300 and about 750 grams. In other specific example of implementations, the mobile member 38 has any other suitable mass.

In some embodiments of the invention, the mobile member 38 defines a central portion 42, and first and second end portions 44 and 46 connected to the central portion 42. The central portion 42 is of a diameter relatively smaller than the end portions 44 and 46, thereby defining the handle. However, in alternative embodiments of the invention, the handle is defined in any other suitable manner.

The end portion 46 defines a substantially flat impact surface 48 for transmitting the impact force to the stopping member 26.

The gripping portion 14 is now described in further details with reference to FIGS. 2, 3 and 5. The gripping portion 14 includes a body 58 defining a cavity 50. The gripping portion 14 includes a first mobile jaw 52 provided, at least in part, within the cavity 50. The first mobile jaw is for gripping the object 12 by moving within the cavity 50.

The gripping portion 14 further includes a second jaw 54. In the embodiment of the invention shown in the drawings, the first and second jaws 52 and 54 are both mobile jaws. However, in alternative embodiments of the invention, only one jaw 52 is provided or alternatively an immobile jaw and a mobile jaw 52 are provided.

The cavity 50 defines an opening 56. The cavity 50 is tapered towards the opening 56. The first and second jaws 52 and 54 are inserted within the cavity and intersect the opening 56.

The cavity 50 is defined within a body 58 of the gripping portion 14, the cavity being defined by first and second tapered inner surfaces 60, 62 and by first and second lateral inner surfaces 64 and 66. The first and second tapered inner surfaces 60 and 62 are angled at an acute angle with respect to each other, and the first and second lateral surfaces 66 and 64 are substantially parallel (shown in FIG. 5).

The jaws 52 and 54 define respective gripping surfaces 72 and 74. The gripping surfaces 72 and 74 are substantially parallel to each other and configured and sized for gripping the object 12.

The gripping surfaces 72 and 74 are any suitable surface. For example, the gripping surfaces 72 and 74 each include at least one tooth 76. The tooth 76 defines a first tooth surface 78 that is substantially acutely angled with respect to the gripping surface 72 or 74 on which it resides, and a second tooth surface 80 that is substantially perpendicular to the gripping surface 72 or 74 on which it resides. The first tooth surface 78 is angled such as to facilitate an insertion of the object 12 between the first and second jaws 52 and 54. In some embodiments of the invention, as shown in the drawings, each of the jaws 52 and 54 includes a plurality of teeth 76.

The first and second jaws 52 and 54 further include respectively first and second cavity contact surfaces 82 and 84. The cavity contact surfaces 82 and 84 contact respectively the tapered inner surfaces 60 and 62. In a specific embodiment of the invention, the cavity contact surfaces 82 and 84 are substantially parallel to the tapered inner surfaces 60 and 62 when the contact surfaces 52 and 54 are substantially parallel to a longitudinal axis of the cavity 50.

The first and second lateral surfaces 64 and 66 are defined by first and second lateral panels 86 and 88 that are removably attached to the gripping portion. In some embodiments of the invention, the lateral panels 86 and 88 are each maintained by respective substantially U-shaped lids provided in the gripping portion 14 defining slits 90. The lateral panels 86 and 88 are also maintained in place by a fastener, such as a screw 92 that is inserted within a corresponding threaded bore (not shown in the drawings), of the gripping portion 14.

Having lateral panels that are relatively easily removable from the gripping portion 14 makes an assembly of the tool 10 relatively easy to perform.

The jaws 52 and 54 are biased towards the opening 56 by a biasing element provided within the cavity 50. In some embodiments of the invention, the biasing element includes a spring 92. In addition, the biasing element includes a contact plate 94 connected to the spring 92. The contact plate 94 is for contacting the first and second mobile jaws 52 and 54 so as to transmit thereto a biasing force exerted by the spring 92. However, the reader skilled in the art will readily appreciate that any suitably manner of biasing the jaws 52 and 54 towards the opening 56 is used in alternative embodiments of the invention.

In use, as better shown in FIGS. 4 and 6, the tool 10 is first moved toward the object 12 such as to insert the object 12 between the jaws 52 and 54. The jaws 52 and 54 are shaped such that the object 12 is relatively easily insertable therebetween. To provide space between the jaws 52 and 54 such that the object 12 is insertable therebetween, the jaws 52 and 54 move within the cavity 50 substantially away from the opening 60. This is made possible because of the tapered nature of the cavity and of the orientation of the cavity contact surfaces 82 and 84.

Subsequently, the mobile member 20 is moved from a proximity of the gripping portion 14 towards the stopping member 26. This motion is effected by an intended user either relatively slowly or relatively swiftly, depending upon the magnitude of the impact force to generate. Higher velocities of the mobile member 20 at the stopper 22 create larger impact forces onto the stopper 26.

When the surface 48 impacts the stopper 26, the energy accumulated into the mobile section 20 is transmitted to the stopper 26 and subsequently to the gripping portion 14. Because of the direction of the impact, the gripping portion has a tendency to move away from the object 12.

However, the teeth 76 grip the object 12, the gripping force being larger with larger impacts. This is caused by the tapered nature of the cavity 60, which forces the jaws 52 and 54 towards each other with a force that is substantially proportional to the impact force. Accordingly, when a large force is exerted on the jaws 52 and 54, the object 12 is gripped with more force, which in suitable embodiments of the invention makes the jaws 52 and 54 immobile with respect to the object 12.

Since the impact force is directed substantially away from the gripping portion 14, and therefore from the object 12, a net effect of pulling the object 12 is produced. Therefore, any force retaining the object 12, such as the friction force, is overcome if the impact force is suitably large. In this case, the object 12 moves with the impact tool 10.

When the object 12 is extracted, an intended user may remove the object 12 from the tool 10 simply by pushing onto the jaws 52 and 54 so as to substantially eliminate a force pushing the contact surfaces 72 and 74 towards each other. Then, the user relatively easily removes the object 12 from the impact tool 10.

In alternative embodiments of the invention, a handle is connected to a gripping portion but not mobile onto a guiding section. For example, a handle is connected to a shaft that is itself connected to the gripping portion. In this case, a user simply exerts a force on the handle, and when a force is directed substantially away from the gripping portion 14, the jaws 52 and 54 are forced substantially towards each other as described hereinabove.

In this case, therefore, there is no impact force generated and the user simply pulls on the object 12 through the handle. However, similarly to what is described hereinabove, the gripping force increases with an extraction force exerted onto the handle by the user.

In other words, an extraction tool 10 is for extracting the object 12 and is usable by the user. The tool 10 includes a first jaw 52 including a first gripping surface 72 for gripping the object 12. The first jaw further including an external surface, such as the cavity contact surface 82, that is substantially opposed to the first gripping surface 52. The tool 10 further includes a second jaw 54 including a second gripping surface 54 for gripping the object 12 and an actuator contacting the first jaw 52 through the external surface. A non-limitative example of such an actuator is the body 58.

The first and second jaws 52 and 54 are coupled together for movement between an open and a closed configuration. In the open configuration the object 12 is mobile between the first and second gripping surfaces 52 and 54. In the closed configuration, the object 12 is gripped by the first and second gripping surfaces. The actuator is configured and sized so that upon the user exerting a force on the tool 10 directed substantially away from the object 12, the actuator exerts a force on the external surface directed so that the first and second gripping surfaces 52 and 54 are pressed substantially towards each other to adopt the closed configuration.

Although the present invention has been described hereinabove by way of preferred embodiments thereof, it can be modified, without departing from the spirit and nature of the subject invention as defined in the appended claim.

What is claimed is:

1. An extraction tool for extracting an object, said extraction tool comprising:
a. a gripping portion for gripping the object; and
b. an impact generating portion connected to said gripping portion, said impact generating portion including
i. a guiding section;
ii. a mobile section connected to said guiding section and mobile with respect thereto; and
iii. a stopper connected to said guiding section for stopping a motion of said mobile section;
c. wherein upon said mobile section being accelerated towards said stopper and thereafter stopped thereby, said mobile section exerts an impact force onto said stopper, the impact force being transmitted to the object through said gripping portion, the impact force being directed substantially away from said gripping portion.

2. An extraction tool as defined in claim 1, wherein said guiding section includes a shaft of substantially uniform cross-section.

3. An extraction tool as defined in claim 2, wherein said stopper includes a stopping member connected to said shaft and extending at least in part outwardly and radially therefrom, said stopper defining a flange substantially perpendicular to said shaft.

4. An extraction tool as defined in claim 2, wherein said shaft is removably attached to said stopper and to said gripping portion.

5. An extraction tool as defined in claim 4, wherein said mobile member defines a handle for receiving a hand of a user.

6. An extraction tool as defined in claim 1 wherein:
a. said gripping portion defines a cavity; and
b. said gripping portion includes a first mobile jaw provided at least in part within said cavity, said first mobile jaw gripping the object by moving within said cavity.

7. An extraction tool as defined in claim 6, wherein said cavity defines an opening, said cavity being tapered towards said opening.

8. An extraction tool as defined in claim 7, wherein:
a. said gripping portion includes a second jaw;
b. said first mobile jaw defines a first gripping surface;
c. said second jaw defines a second gripping surface; and
d. said first and second gripping surface are substantially parallel and are for gripping the object.

9. An extraction tool as defined in claim 8, wherein said second jaw is a second mobile jaw mobile within said cavity.

10. An extraction tool as defined in claim 9, wherein said first and second mobile jaws are biased towards said opening by a biasing element provided within said cavity.

11. An extraction tool for extracting an object, said extraction tool being usable by a user, said extraction tool comprising:
a. a gripping portion for gripping the object, said gripping portion including:
i. a body;
ii. a first mobile jaw, said first mobile jaw being connected to said body and mobile with respect thereto, said first mobile jaw including at least one first jaw tooth for engaging said object;
iii. a second jaw including at least one second jaw tooth for engaging said object, said second jaw being coupled to said body; and
b. a handle connected to said body;
c. wherein said body and said first and second jaws are configured and sized for gripping said object with a gripping force, the gripping force increasing with an extraction force exerted onto said handle by the user, the extraction force being exerted by the user substantially away from the object.

12. An extraction tool as defined in claim 11, wherein said second jaw is a second mobile jaw mobile with respect to said body;

13. An extraction tool as defined in claim 12, wherein said first and second jaws each include respectively a plurality of first jaw teeth and a plurality of second jaw teeth.

14. An extraction tool as defined in claim 13, wherein said first and second jaws each define respectively a first jaw contact surface and a second jaw contact surface, said first and second jaw contact surfaces defining respectively said plurality of first and second jaw teeth, each teeth from said plurality of first and second jaw teeth being defined by a respective back surface substantially perpendicular to said first and second jaw contact surfaces and a respective front surface substantially acutely angled with respect to said first and second jaw contact surfaces.

15. An extraction tool as defined in claim 11, further comprising substantially elongated and substantially rectilinear shaft, said shaft being connected to said body, said handle being mounted onto said shaft.

16. An extraction tool as defined in claim 15, wherein:
a. said handle is slidably mounted onto said shaft;
b. said extraction tool further comprises a stopper connected to said shaft for stopping a motion of said handle; and
c. upon said handle being accelerated towards said stopper and thereafter stopped thereby, said handle exerts an impact force onto said stopper, the impact force being transmitted to the object through said first and second jaws, the impact force being directed substantially away from said body.

17. An extraction tool as defined in claim 16, wherein said shaft is of substantially uniform cross-section.

18. An extraction tool as defined in claim 17, wherein said stopper includes a stopping member connected to said shaft and extending at least in part outwardly and radially therefrom.

19. An extraction tool as defined in claim 18, wherein said stopper defines a flange substantially perpendicular to said shaft.

20. An extraction tool as defined in claim 25, wherein said shaft is removably attached to said stopper and to said body.

21. An extraction tool as defined in claim 20, wherein:
a. said shaft includes first and second threaded ends;
b. said body defines a body threaded bore for receiving said first threaded end; and
c. said stopper defines a stopper threaded bore for receiving said second threaded end.

22. An extraction tool as defined in claim 18, wherein said handle defines an insertion bore extending therthrough, said insertion bore being for receiving at least in part said shaft.

23. An extraction tool as defined in claim 20 wherein:
a. said body defines a cavity; and
b. said first mobile jaw is provided at least in part within said cavity;
c. said second mobile jaw is provided at least in part within cavity; and
d. said first and second mobile jaws grip the object by moving within said cavity.

24. An extraction tool as defined in claim 23, wherein said cavity defines an opening, said cavity being tapered towards said opening.

25. An extraction tool as defined in claim 24, wherein said cavity is defined by first and second tapered inner surfaces and first and second lateral inner surfaces, said first and second tapered inner surfaces being angled at an acute angle with respect to each other and said first and second lateral surface being substantially parallel.

26. An extraction tool as defined in claim 25, wherein:
a. said gripping portion includes a second jaw;
b. said first mobile jaw defines a first gripping surface;
c. said second jaw defines a second gripping surface;
d. said first and second gripping surface are substantially parallel and are for gripping the object.

27. An extraction tool as defined in claim 26, wherein said first and second lateral surfaces are defined by first and second lateral panels removably attached to said body.

28. An extraction tool as defined in claim 27, wherein said first and second mobile jaws are biased towards said opening by a biasing element provided within said cavity.

29. An extraction tool as defined in claim 28, wherein said biasing element includes a spring.

30. An extraction tool as defined in claim 29, wherein said biasing element includes a contact plate connected to said spring for contacting said first and second mobile jaws and transmitting thereto a biasing force exerted by said spring.

31. An extraction tool for extracting an object, said extraction tool being usable by a user, said extraction tool comprising:
a. a first jaw including a first gripping surface for gripping the object, said first jaw further including an external surface substantially opposed to said first gripping surface;
b. a second jaw including a second gripping surface for gripping the object; and
c. an actuator contacting said first jaw through said external surface;
d. wherein:
i. said first and second jaws are coupled together for movement between an open and a closed configuration, in said open configuration the object being mobile between said first and second gripping surfaces and in said closed configuration the object being gripped by said first and second gripping surfaces; and
ii. said actuator is configured and sized so that upon the user exerting a force on said tool directed substantially away from the object, said actuator exerts a force on said external surface directed so that said first and second gripping surfaces are pressed substantially towards each other to adopt said closed configuration.
